(19) United States
(12) Patent Application Publication
(10) Pub. No.: US 2014/0095349 A1
(43) Pub. Date: Apr. 3, 2014

(54) System and Method for Facilitating Social E-Commerce

(71) Applicants: James L. Mabrey, Dallas, TX (US); Robert Brooks, JR., Plano, TX (US); Jarrod Brooks, Mansfield, TX (US)

(72) Inventors: James L. Mabrey, Dallas, TX (US); Robert Brooks, JR., Plano, TX (US); Jarrod Brooks, Mansfield, TX (US)

(21) Appl. No.: 14/028,246

(22) Filed: Sep. 16, 2013

Related U.S. Application Data
(60) Provisional application No. 61/701,420, filed on Sep. 14, 2012.

(51) Int. Cl. G06Q 30/06; G06Q 50/00

(52) U.S. Cl. CPC G06Q 30/0643; G06Q 30/0641; G06Q 30/0633; G06Q 50/01
USPC 705/26.8; 705/27.1; 705/27.2

(57) ABSTRACT

A software application providing a social, interactive panoramic shopping experience from pictures. The experience should be based upon navigable panoramic spaces from photographs that include the capability for users to interact socially and individually with particular elements within that space

This application claims the benefit of U.S. Provisional Patent Application No. 61/701,420 filed 14 Sep. 2012, titled “SYSTEM AND METHOD FOR FACILITATING SOCIAL E-COMMERCE,” which is hereby incorporated by reference for all purposes as if fully set forth herein.

### BACKGROUND

1. Field of the Invention

The present invention is directed to the creation of a realistic, social-commerce experience using panoramic and/or three-dimensional visual rendering of physical spaces wherein consumers may purchase and browse products individually or with friend and family.

2. Description of Related Art

Current state of the art is such that there are several known methods for capturing, rendering, and stitching panoramic images. There also exist several known methods of rendering such a panoramic image navigable in all directions (360 degree spherical images) by using keyboard, mouse, or keypad commands. Several known methods also exist for linking several panoramic images to convey the sense of moving through a continuous, connected space. While there are many methods for capturing, rendering, and stitching panoramic images such that the panoramic image is navigable in all directions while conveying the sense of moving through a connected space well known in the art, considerable room for improvement remains.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a perspective view of the stitched and blended panoramic photographs according to the present application;

FIG. 2 is a perspective view of the navigable, interactive, and panoramic environment according to the present application;

FIG. 3 is a perspective view of the navigable, interactive, panoramic environment with an embedded window providing additional product views and information according to the present application;

FIG. 4 is a perspective view of a turnorama of a purse according to the present application;

FIG. 5 is a perspective view of the method for selecting different racks of items according to the present application and a method for browsing through a rack of items according to the present application;

FIG. 6 is a perspective view of the alternative method for browsing through a rack of items according to the present application;

FIG. 7 is a perspective view of the “dressing room” where shoppers can compare articles of clothing to make an outfit from the navigable, interactive, panoramic environment according to the present application;

FIG. 8 is a perspective view of the alternative method for the “dressing room” where shoppers can compare articles of clothing to make an outfit from the navigable, interactive, panoramic environment according to the present application;

FIG. 9 is a perspective view of another alternative method for the “dressing room” where shoppers can compare articles of clothing to make an outfit using a drag and drop feature from the navigable, interactive, panoramic environment according to the present application;

FIG. 10 is a perspective view of the navigable, interactive, panoramic environment displaying multiple languages according to the present application;

FIG. 11 is a perspective view of the navigable, interactive, panoramic environment from the first of two different stores while in a single transaction according to the present application;

FIG. 12 is a perspective view of the navigable, interactive, panoramic environment from the second of two different stores while in a single transaction according to the present application;

FIG. 13 is a perspective view of the navigable, interactive, panoramic environment with a help suggestion box and with a help dialog box according to the present application;

FIG. 14 is a perspective view of the navigable, interactive, panoramic environment shared by a group of individuals according to the present application;

FIG. 15 is a perspective view of the navigable, interactive, panoramic environment with a clickable option to switch back and forth between the flat site and the virtual store.

FIG. 16 is a perspective view of the alternative embodiment of a navigable, interactive, panoramic environment on a tablet according to the present application;

FIG. 17 is a perspective view of the alternative embodiment of a navigable, interactive, panoramic environment on a smart phone according to the present application;

FIG. 18 is a perspective view of a navigable, interactive environment on a television according to the present application;

FIG. 19 is a perspective view of a distribution method of a navigable, interactive environment on a television according to the present application;

FIG. 20 is a perspective view of a distribution method for the system user to link particular panoramic images from the database to the Mini Map according to the present application;

FIG. 21 is a perspective view of the retailer's current inventory system linked with the navigable, interactive, panoramic environment according to the present application;

FIG. 22 is an alternative perspective view of the retailer's current inventory system linked with the navigable, interactive, panoramic environment using a drag and drop method according to the present application;

FIG. 23 is an alternative perspective view of the inventory system linked with recognition software for product identification in the navigable, interactive, panoramic environment according to the present application;

FIG. 24 is a perspective view of the progressively loading panoramic images as they are bound to the shoppers' viewport in the navigable, interactive, panoramic environment according to the present application;

FIG. 25 is a perspective view of the ability for online only retailers to create a realistic, lifelike and navigable interactive, panoramic environment according to the present application;

FIG. 26 is a perspective view of navigation through multiple floors using the elevator in the navigable, interactive, panoramic environment according to the present application;

FIG. 27 is a perspective view of the navigable, interactive, and panoramic environment according to the present application;

FIG. 28 is a perspective view of web page for a group of virtual stores linked with the navigable, interactive, panoramic environment according to the present application;

FIG. 29 is a perspective view of web page for a group of items for sale linked with the navigable, interactive, panoramic environment according to the present application;

FIG. 30 is a perspective view of the add to dressing system linked with the navigable, interactive, panoramic environment according to the present application;

FIG. 31 is a perspective view of web page for a virtual dressing room linked with the navigable, interactive, panoramic environment according to the present application;

FIG. 32 is a perspective view of web page for a virtual dressing room highlighting the social aspect linked with the navigable, interactive, panoramic environment according to the present application;

FIG. 33 is a perspective view of web page for a virtual shopping cart linked with the navigable, interactive, panoramic environment according to the present application;

FIG. 34 is an alternative perspective view of the retailer's current inventory system linked with the navigable, interactive, panoramic environment using a drag and drop method according to the present application;

FIG. 35 is an alternative perspective view of the retailer's current inventory system linked with the navigable, interactive, panoramic environment using a drag and drop method according to the present application; and

FIG. 36 is an alternative perspective view of the retailer's current inventory system linked with the navigable, interactive, panoramic environment using a drag and drop method according to the present application.

While the systems and methods of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application.

### DETAILED DESCRIPTION OF THE PREFERRED EMBODIMENT

Illustrative embodiments of the system and method for facilitating social panoramic e-commerce are provided below. It will of course be appreciated that in the development of any actual embodiment, numerous implementation-specific decisions will be made to achieve the developer's specific goals, such as compliance with assembly-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method involves the creation of software applications to provide a social, interactive panoramic shopping experience. The system and method creates navigable panoramic spaces from photographs that include the capability for users to interact with particular elements within that space. The most immediate application is the creation of an e-ecommerce platform that will allow individuals to shop online as though within an actual store. Customers can browse stores, get additional information/pictures about particular products, purchase products, like/tag products through social networks, add product to a wish list, and get live sales help through text or voice. Customers can also shop with their friends/family despite being separated by geography, time-constraints, etc. . . . Vendors are able to efficiently input and update inventories, provide product information, and link into their pre-existing e-commerce systems or, if they have none, offer a turnkey option.

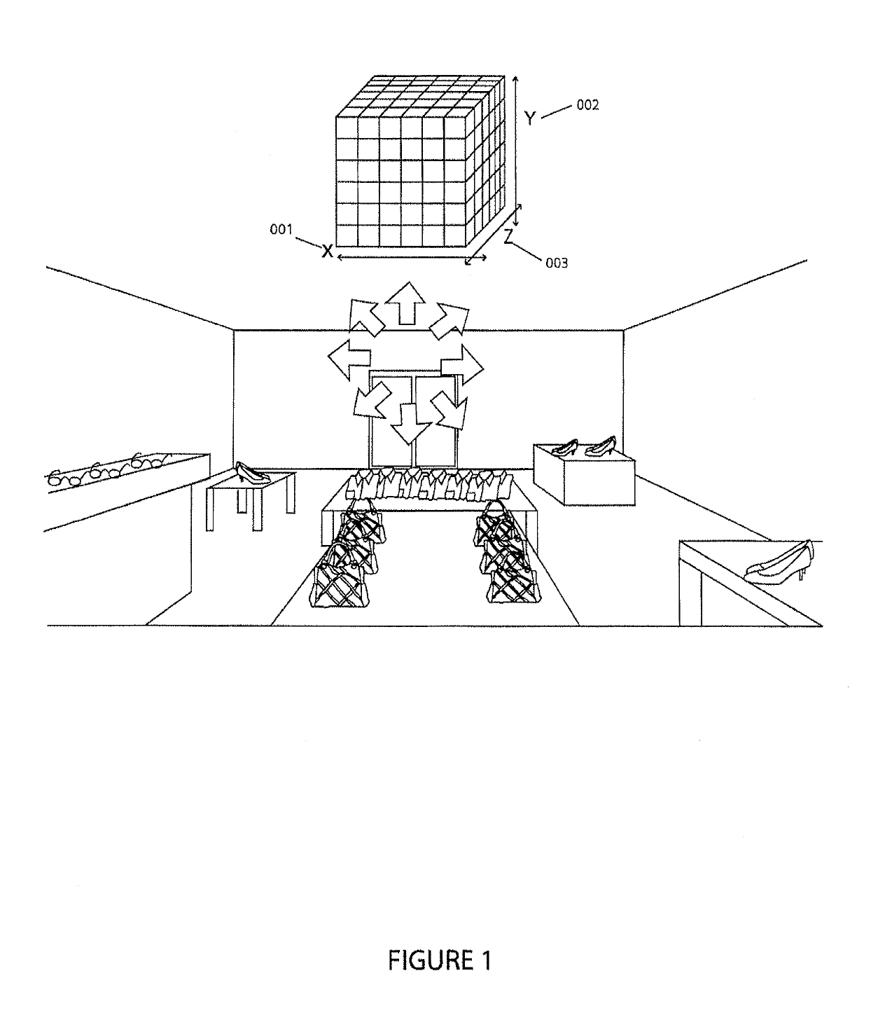

Referring to FIG. 1 in the drawings, a preferred embodiment of the stitched and blended panoramic photographs according to the present application is illustrated. Panorama must be high resolution in order to allow for effective zoom in and zoom out functionality. Several known options exist for stitching and blending. The system takes a standard epirectangular panoramic image and create 6 standard cube faces by using standard interpolation and a check for nearest neighbor within the image (to build the primary array of coordinates for mapping). The process starts by mapping a point on the sphere to a point on the epirectangular image to build the coordinates around it. Then the process straightens the lines out by creating a circumscribed cube (most panoramic tools create an inscribed cube) before making the sphere for the user in the main view. The viewer takes the coordinate assumption (360 degrees) and creates a sphere from the cube faces X (001), Y (002), Z (003) axis. Additionally the viewer allows for both raster and vector based cube faces to be present for scale between resolutions (primarily useful for rendered environments). The preferred embodiment includes fully-interactive, navigable, three dimensional or panoramic spaces wherein businesses can sell, promote, or display goods or services and customers worldwide can shop, browse, and discover goods and services on their own or socially.

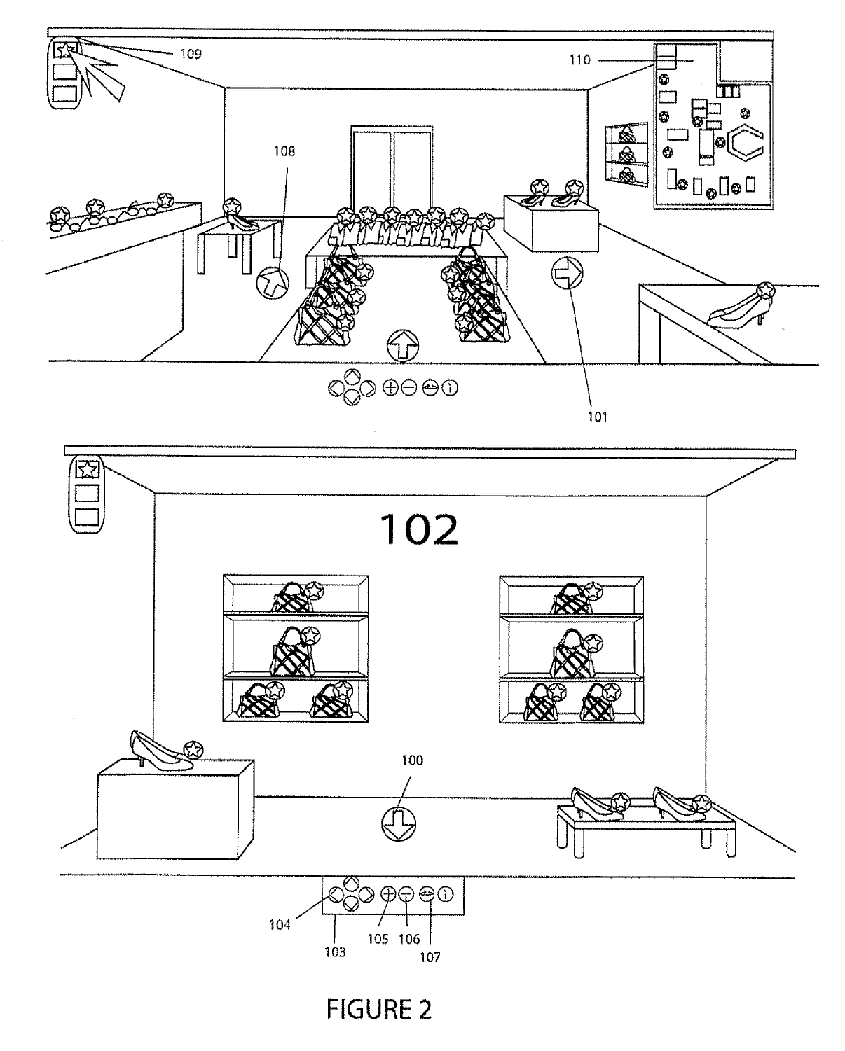

Referring now also to FIG. 2 in the drawings, a preferred embodiment of the omni-navigable, interactive, and panoramic environment according to the present application is illustrated. Use of spherical video camera allows for frequent navigation points which creates the illusion of free movement within a panoramic space with the directional keys on the keyboard, clicking the mouse or by tapping on the screen for smart phones or tablets. By clicking on diagonal navigation point or “hot spot” 101, the shopper jumps to that location in the store 102 and can view all products in that panoramic photo by turning using the navigation bar 103. The shopper can tilt the view angle up, down, left, or right by using the arrows 104; move-in for a closer view of the products 105 or pan out for a broader view 106. The shopper can click on the 360 turn arrow 107 to begin a slow turn until the 360 turn arrow 107 is clicked again. The shopper can maneuver in the same manner as the navigation bar with the mouse by clicking and holding the left button (or in the case of a tablet or smart phone by using their finger on the screen) then by dragging to the left the shopper will move to the right and vice versa, can move up by dragging down and down by dragging up. Shopper can zoom in or out with a roller bar on their mouse. The shopper were moved in the opposite direction. The shopper can easily return to their previous location 100 or jump to another location 108 to view and choose products in that particular panoramic photo. Additionally, shopper can select 109 the drop-down store map feature 110 and jump to any location in the store by selecting the desired hotspot.

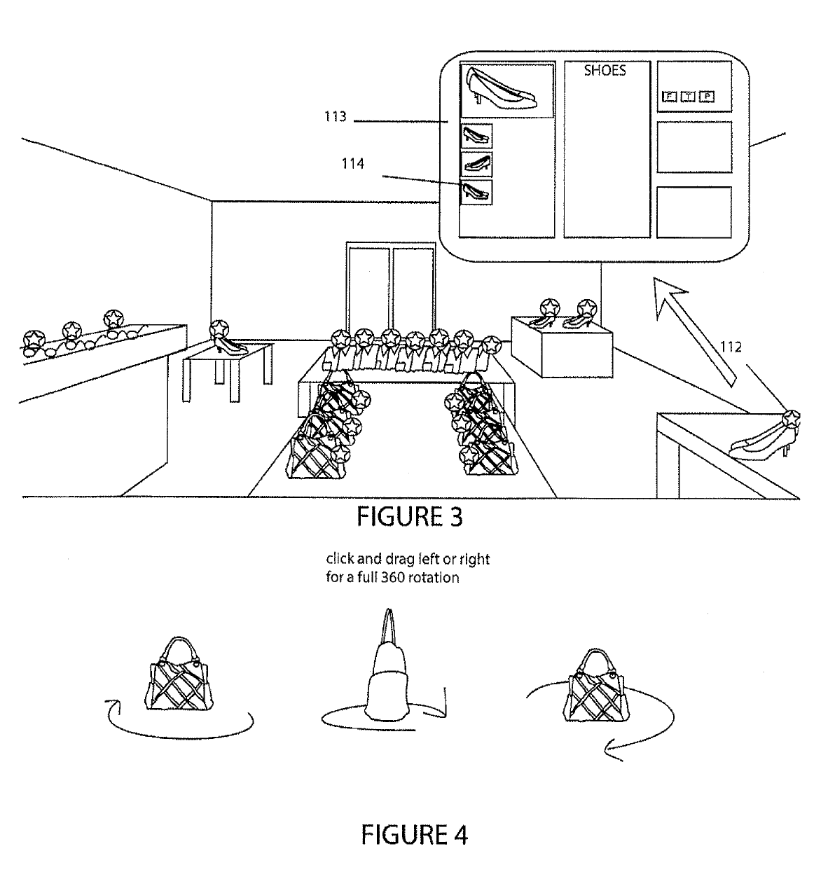

Referring now also to FIG. 3 in the drawings, a preferred embodiment of the navigable, interactive, panoramic environment with an embedded window providing additional product views and information according to the present application is illustrated. By clicking on the virtual price tag 112 an additional embedded window 113 would open. Embedded window 113 provides additional product views and information and allows a shopper to purchase the item(s). Some products will have 360 photos 114 (see FIG. 4) to show all sides of the item.

Referring now also to FIG. 4 in the drawings, preferred embodiments of a turnorama according to the present application are illustrated. Provide the ability to display turnoramas for products so that customers can have the experience of picking up and inspecting a product from all angles. Users should be able to turn the product 360 degrees horizontally and vertically. For example in FIG. 4 the user is able to verify all sides of a purse. Being able to virtually pick up and inspect all sides of the item allows users the mimic interaction normally found in physical stores.

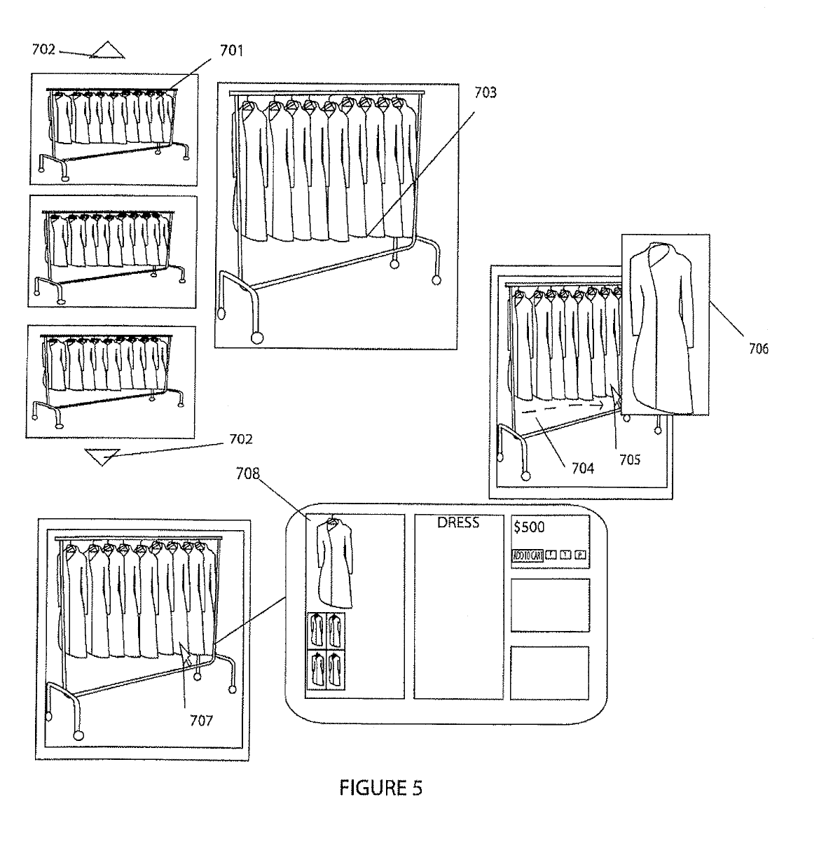

Referring Now Also To FIG. 5 the “Virtual Rack Room” will display racks of clothing for the user to browse through. The shopper will pick the desired rack 701 by scrolling the arrows 702 and will display enlarged in the window 703. Once the rack has been chosen the user can scroll the mouse 704 to hover over the desired article of clothing 705 and a full image of the item will fly out in a window 706. If the User clicks it 707, it will populate in a window with more detail 708 which provides the shopper with or photographic images, information and the ability to purchase the item.

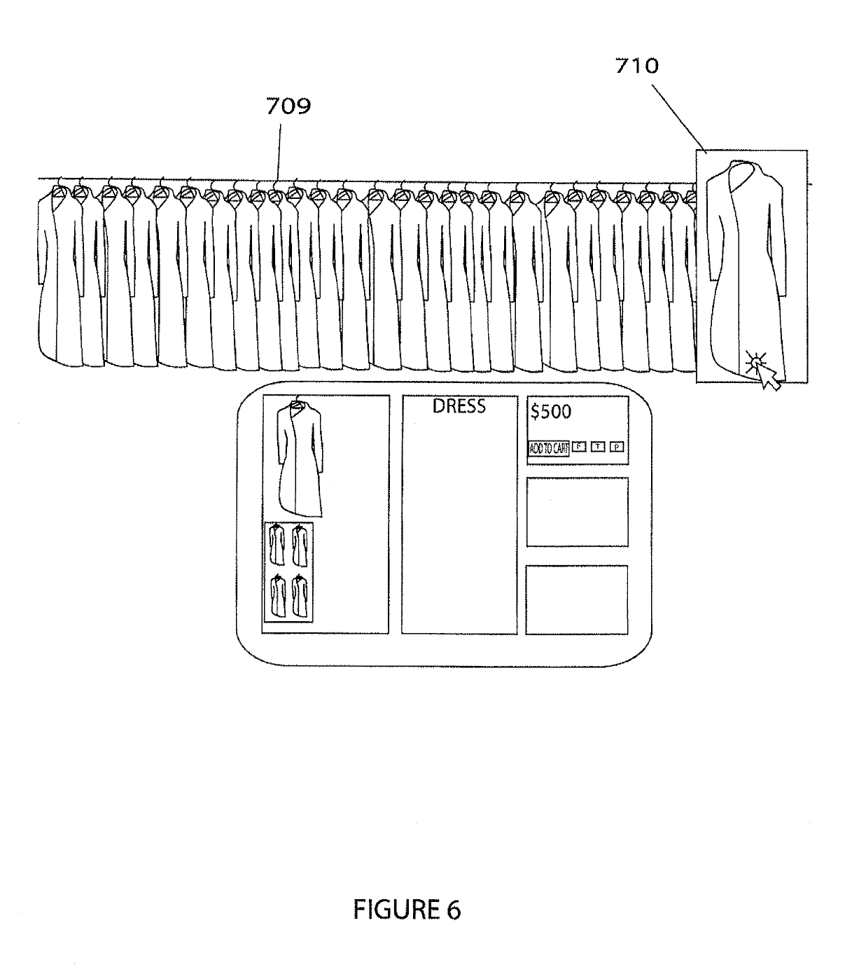

Referring now also to FIG. 6 the “Virtual Rack Room” and will display will appear to be an endless rack of clothing for the user to browse through 709 compiled by assembling a series of photographs taken at the same angles in such a manner that they give the appearance of overlapping products hanging on a rack. When the shopper clicks on an item the product will open up a window for a 360 degree rotational view 710. The rack will be constructed of PNG images tied into an “accordion-like” slider. This will give the system user the ability to add, remove, sort, and design the rack in any way chosen.

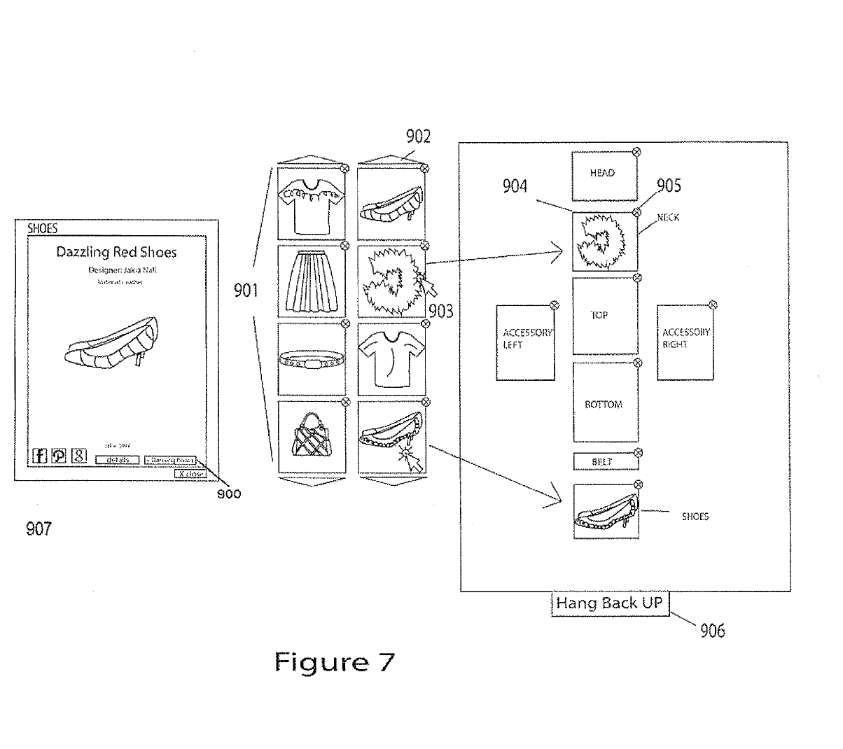

Referring now also to FIG. 7 in the drawings, the Shopper and the salesperson is provided with a rapid and efficient system to compare and match articles of clothing in the “Dressing Room” to create outfits. When the shopper and/or the salesperson is browsing the store, when they select an item there is an option to “send to dressing room” on the pop-up window enabled by clicking the button 900. A list of products 901 will be generated that can be scrolled through using a touch enabled device or using the arrows 902. Click the item from the list 903 and it will appear in the assigned location 904 based on product type, and click the “X” in corner of the box 905 to remove the products individually or use the “hang back up” 906 button to clear the entire area. The shopper can share the products on their favorite social media outlet 907. The shopper and/or salesperson can mix, match, and position each product as he or she likes as illustrated in FIG. 7. Typically, the images are stored on a first networked computer at a centralized location such as the distribution center or a clearinghouse. Remote users would utilize a second networked computer in networked communications with the first networked computer to control the panoramic images and to move about the virtual store. The first networked computer typically includes digital storage for storing the digital images of the panoramic spaces and of the images of the items for sale.

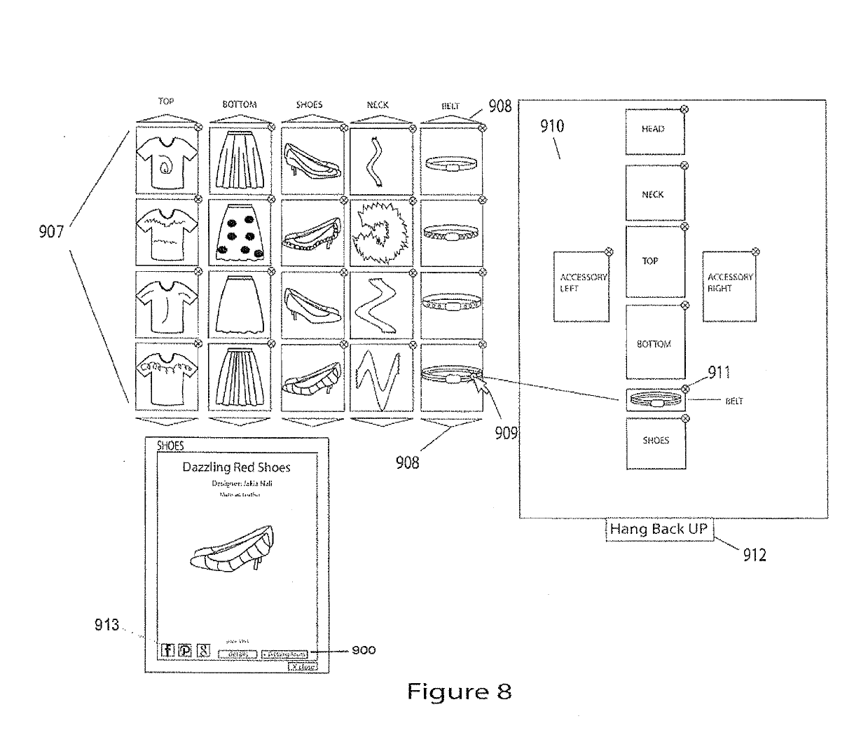

Referring now also to FIG. 8 in the drawings, the Shopper and/or salesperson is provided with an alternative rapid and efficient system to compare and match articles of clothing in the “Dressing Room” to create outfits. When the shopper and/or the salesperson is browsing the store, when they select an item there is an option to “send to dressing room” on the pop-up window enabled by clicking the button 900. A list of products 907 will be generated that can be scrolled through using a touch enabled device or using the arrows 908. Click the item from the list 909 and it will appear in the assigned location 910 based on category, and click the “X” in corner of the box 911 to remove the products individually or use the “hang back up” 912 button to clear the entire area. The shopper can share the products on their favorite social media outlet 913. The shopper and/or salesperson can mix, match, and position each product as he or she likes as illustrated in FIG. 8.

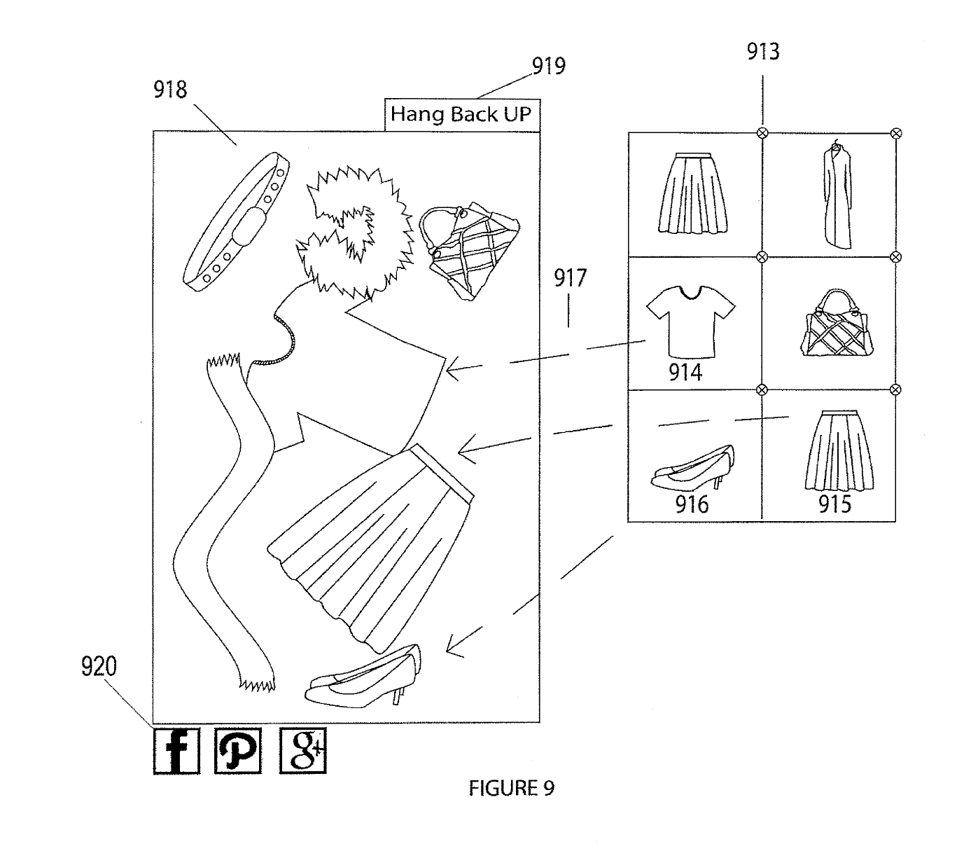

Referring now also to FIG. 9 in the drawings, the Shopper and/or salesperson is provided with an alternative rapid and efficient system to compare and match articles of clothing in the “Dressing Room” to create outfits using the drag and drop method. A list of products 913, such as the blouse 914, the skirt 915, and the shoes 916 can be dragged 917 into the mirror 918 so the shopper and/or salesperson can mix, match, and position each product. To remove the products individually or use the “hang back up” 919 button to clear the entire area. The shopper can share the products on their favorite social media outlet 920.

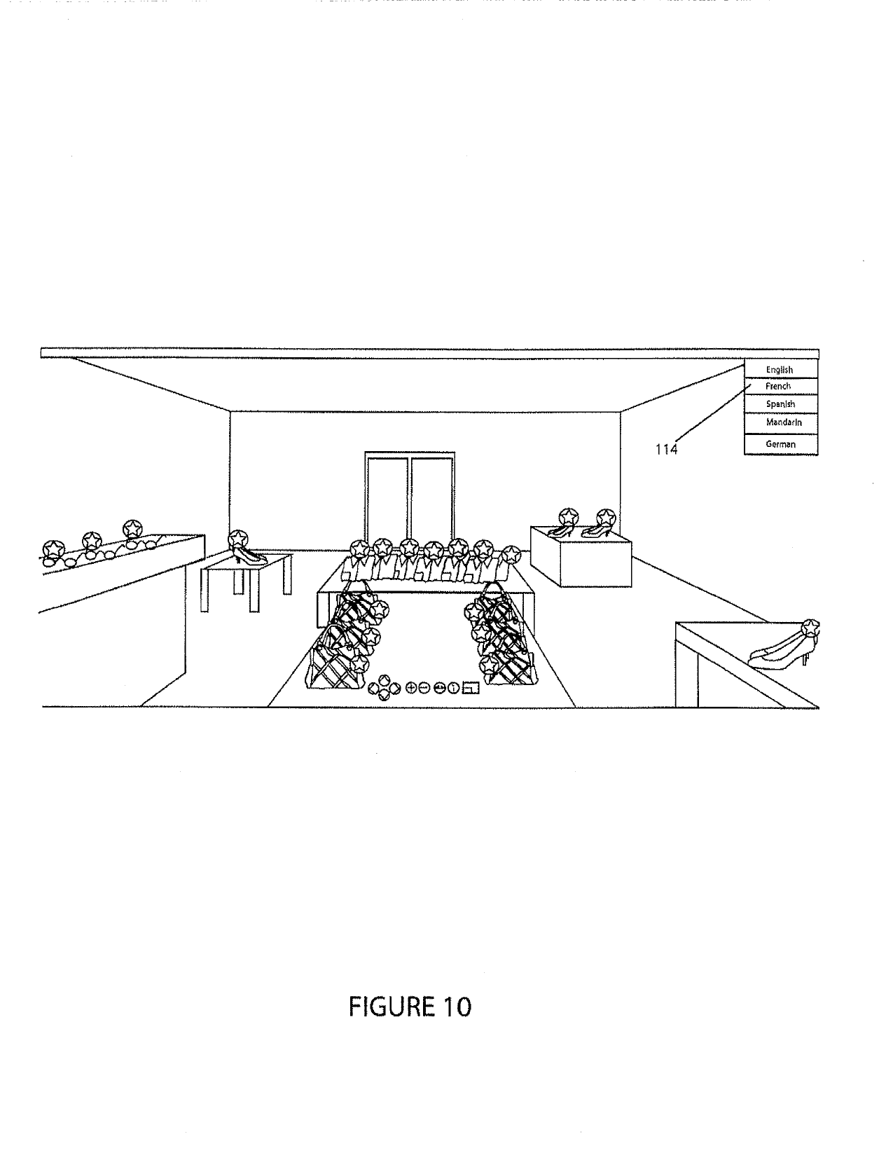

Referring to FIG. 10 in the drawings, a preferred embodiment of the navigable, interactive, panoramic environment displaying multiple languages according to the present application is illustrated. A language menu 114 allows customers to choose their preferred language. Customers from all over the world can shop remotely while receiving information and live sales help in several different languages.

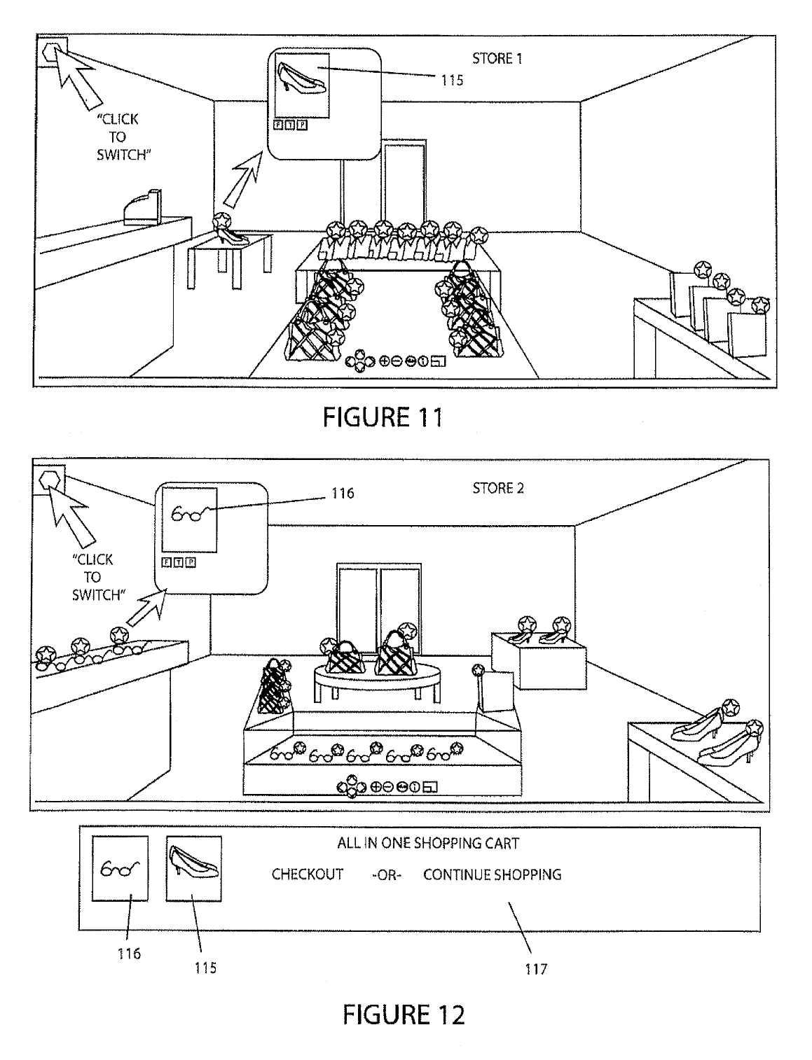

Referring now also to FIG. 11 and FIG. 12 in the drawings, preferred embodiments of the navigable, interactive, panoramic environment from multiple stores while in a single transaction according to the present application are illustrated. Ability to link shopping cart with a retailer's current e-commerce system. Ability to segment a master shopping cart into specific stores, allowing customers to purchase from several stores in a single transaction. Customers only have to enter in their customer profile that includes shipping address, credit card information etc. one time allowing them to navigate several different stores without having to enter payment information for each separate store. Items from store-1 115 are added to same cart as items for store-2 116. Customers can checkout 117 upon leaving a store or pay for items from several stores in a single transaction.

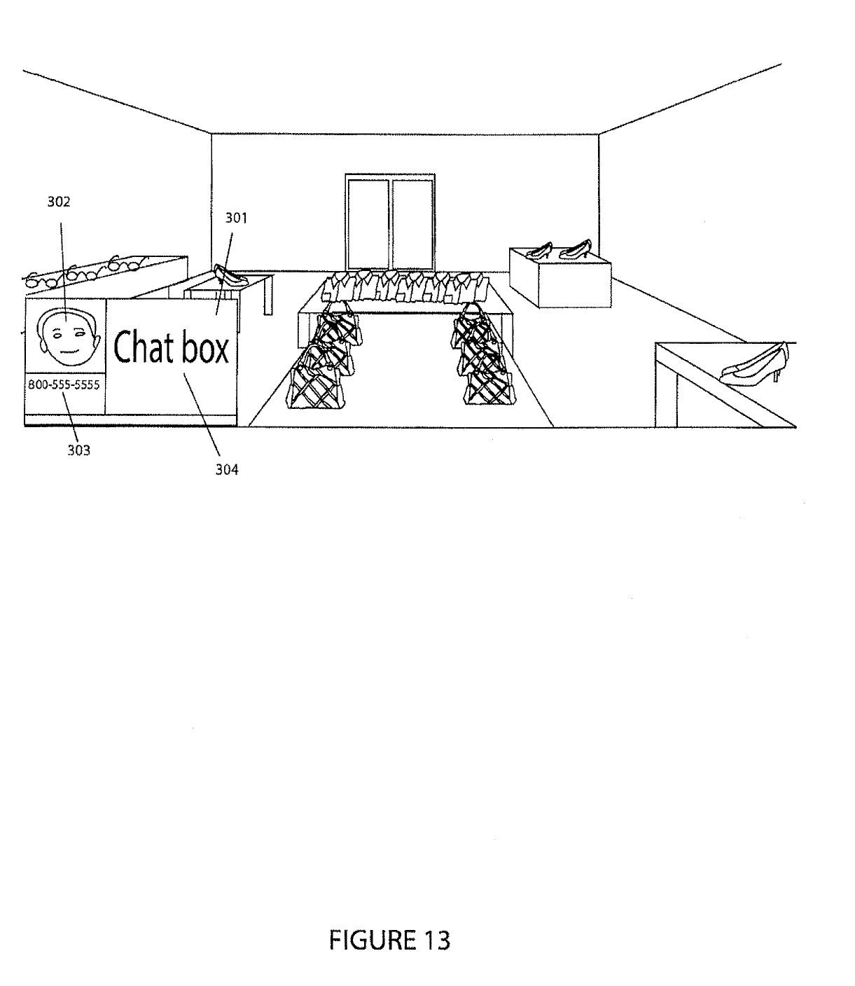

Referring now also to FIG. 13 in the drawings, alternative embodiments of the navigable, interactive, panoramic environment with help boxes according to the present application are illustrated. A help box 301 provides a shopper with the ability to receive live sales help while browsing in the store. Depending on the bandwidth and hardware limitations of the shopper, sales help/suggestions can be provided via live real-time video 302, voice only 303, or in a text-only chat environment 304. In an alternate embodiment consumers are able to navigate and interact with virtual, panoramic spaces in order to purchase goods or services with live salespersons in different time zones and in several different languages throughout the world.

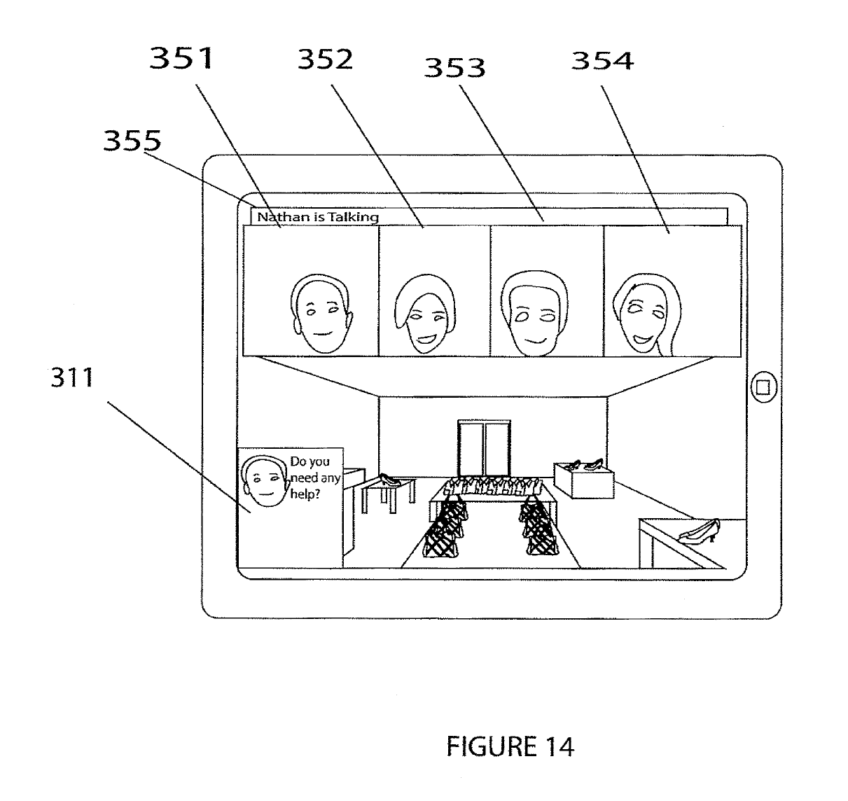

Referring now also to FIG. 14 in the drawings, an alternative embodiment of the navigable, interactive, panoramic environment shared by a group of individuals according to the present application is illustrated. The ability to shop in panoramic store with your friends or family. This feature allows customers to shop with their friends/family/co-workers in order to replicate the real-life social aspect of shopping by browsing the aisles together. Customers are then able to solicit opinions on items, make and receive suggestions, indicate desired gifts, etc. . . . Ability to purchase items on behalf of friends or family. Ability to share, alternate control of the shop view. Multiple users can shop together and interact with live sales help 311 such as user 351, user 352, user 353, and user 354. An indicator 355 could display which user has the control of the shop view, or who is speaking, etc. providing the ability of the salesperson to lead the shoppers through the store to view suggested purchases. The shoppers and salesperson are able to navigate and interact with virtual, panoramic spaces in order to purchase goods or services simultaneously with friends or family. Depending on the bandwidth and hardware limitations of the shoppers, the social shopping experience can be provided via live real-time video, voice only, or in a text-only chat environment.

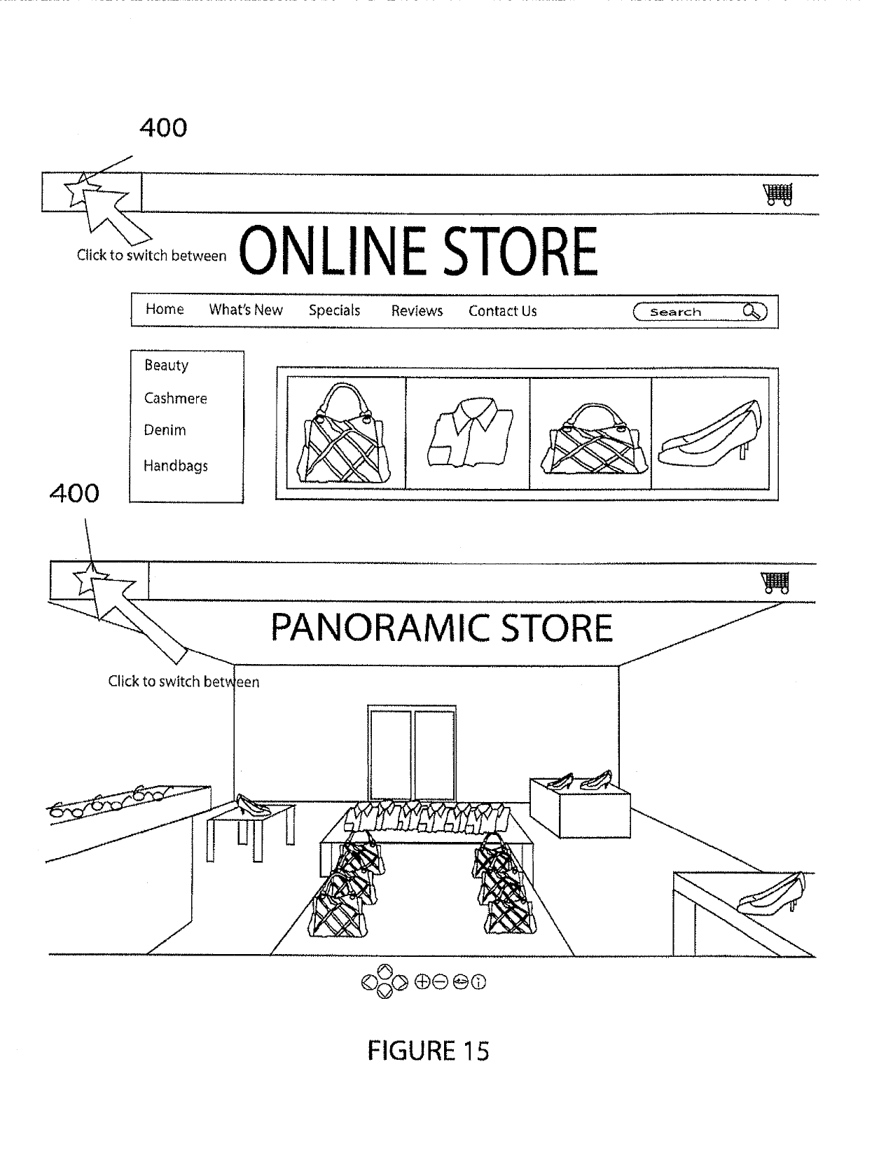

Referring now to FIG. 15 in the drawings, an alternative embodiment of the navigable, interactive, panoramic environment enabling the user to switch back and forth between the panoramic and standard “flat site” environment to the present application is illustrated. Shopper can browse the aisles similar to a normal real-life shopping environment by entering the panoramic store or select a standard “flat site” environment by clicking on the toggle switch 400.

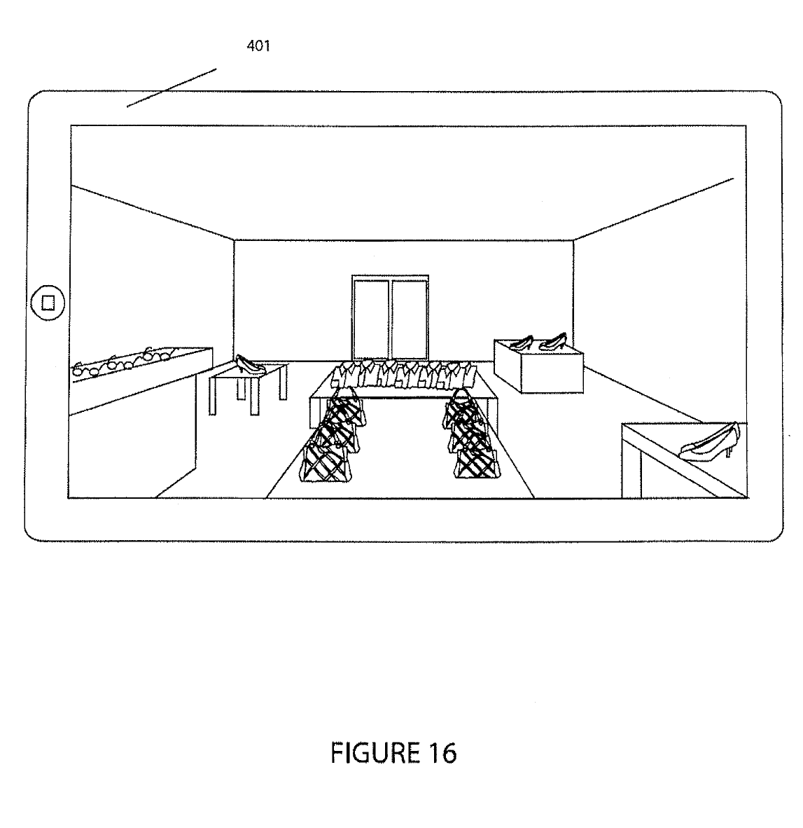

Referring now also to FIG. 16 in the drawings, an alternative embodiment of the navigable, interactive, panoramic environment on a tablet according to the present application is illustrated. The application could be utilized on a tablet 401. The functionality between the application run on a computer and on a tablet 401 would be virtually the same. Typically, the tablet 401 would include a screen, preferably a touch screen. Also the tablet 401 includes a camera capable of taking video of the user to transmit to friends, family, or store personnel. Because of the social aspects, the tablet 401 includes a microphone and speaker to allow for a proper social interaction such as discussing how one bag is better looking than the second bag. Tablet 401 has networked communications with the server to allow data to transfer between the user and the system. To aid the system the tablet 401 can include local memory, thereby allowing the system to locally store panoramic images on the tablet and reduce the required bandwidth.

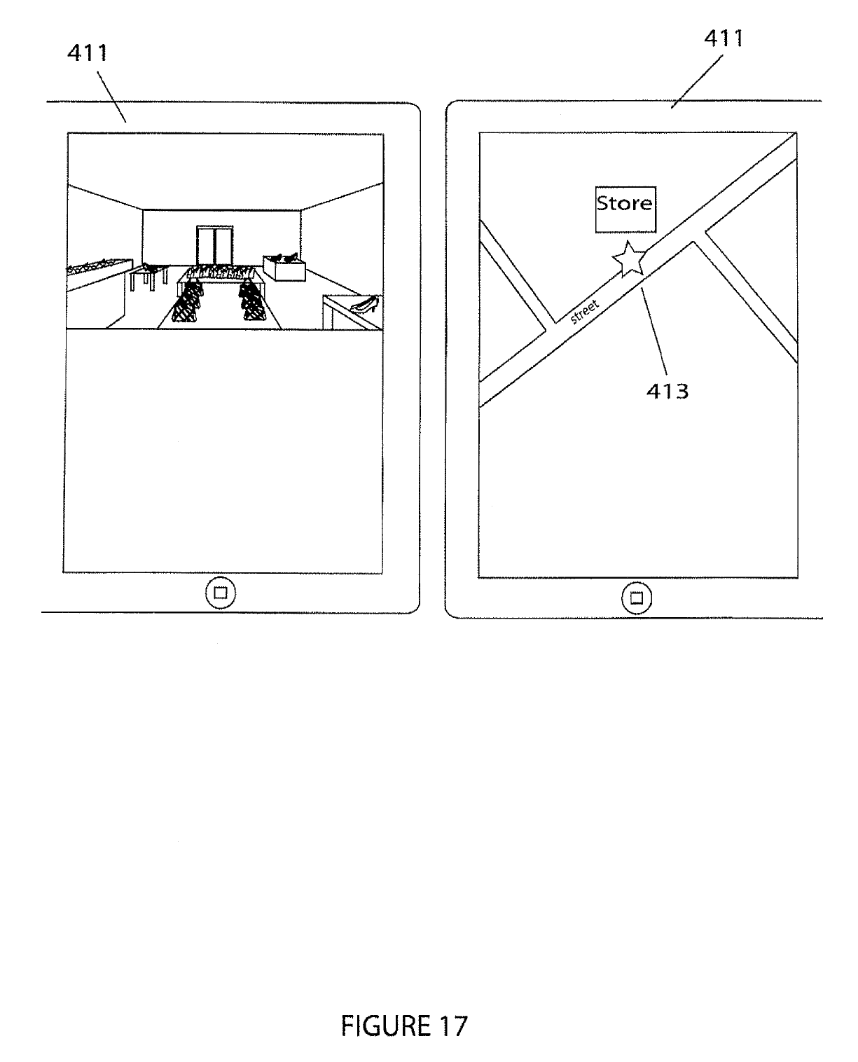

Referring now also to FIG. 17 in the drawings, alternative embodiments of the navigable, interactive, panoramic environment on a smart phone according to the present application are illustrated. The application could be utilized on a smart phone 411. The functionality between the application run on a computer and on a smart phone 411 would be virtually the same and could include a geo-locating of products on a map 413. Additional information about stores including store location, directions to stores, store hours, payment methods, amenities, review, etc. . . .

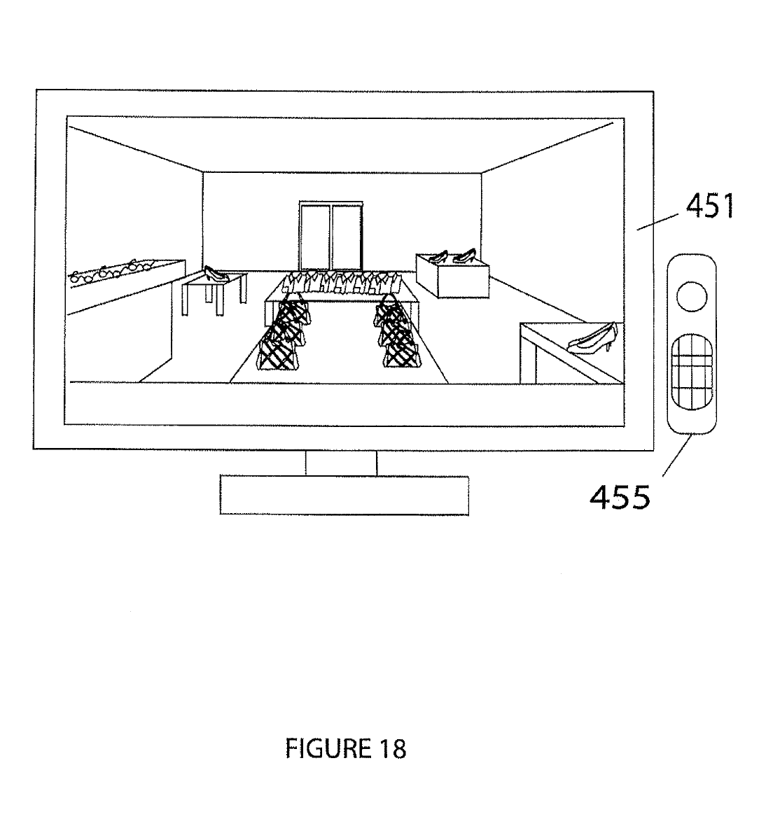

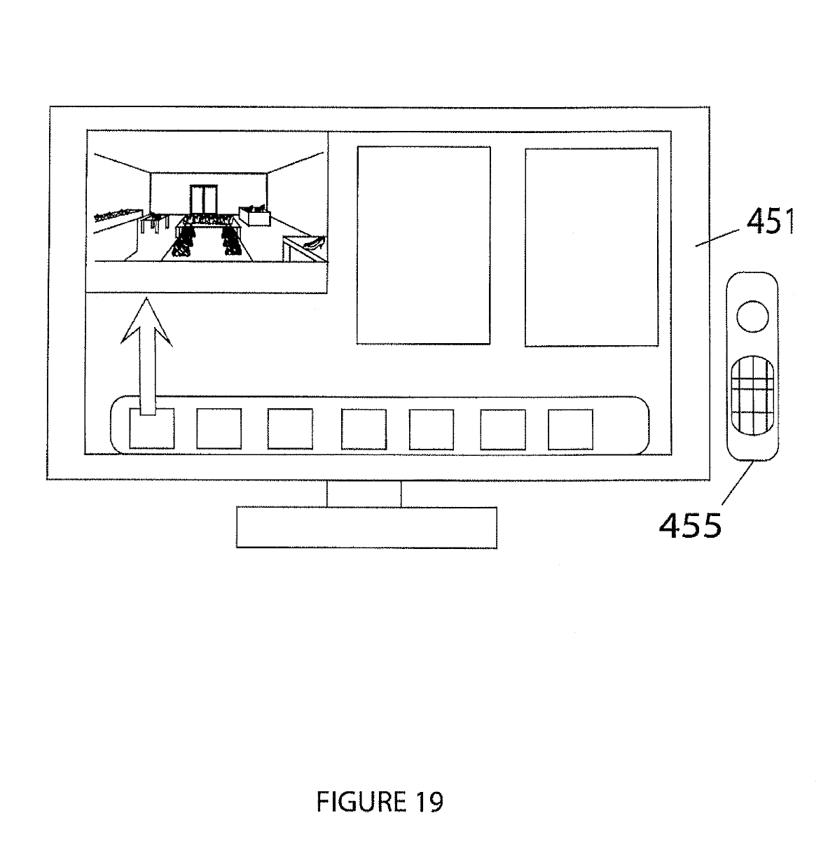

Referring now also to FIG. 18 and FIG. 19 in the drawings, alternative embodiments of the navigable, interactive, panoramic environment on a television according to the present application are illustrated. The application could be utilized on a smart-television 451. The functionality between the application run on a computer and on a smart-television 451 would be virtually the same with the ability to search by product, store, or category, reviews, deals, and the ability to purchase, like, wish list, or suggest items to friends/family. The application is accessed and controlled by interfacing with any standard TV remote 455.

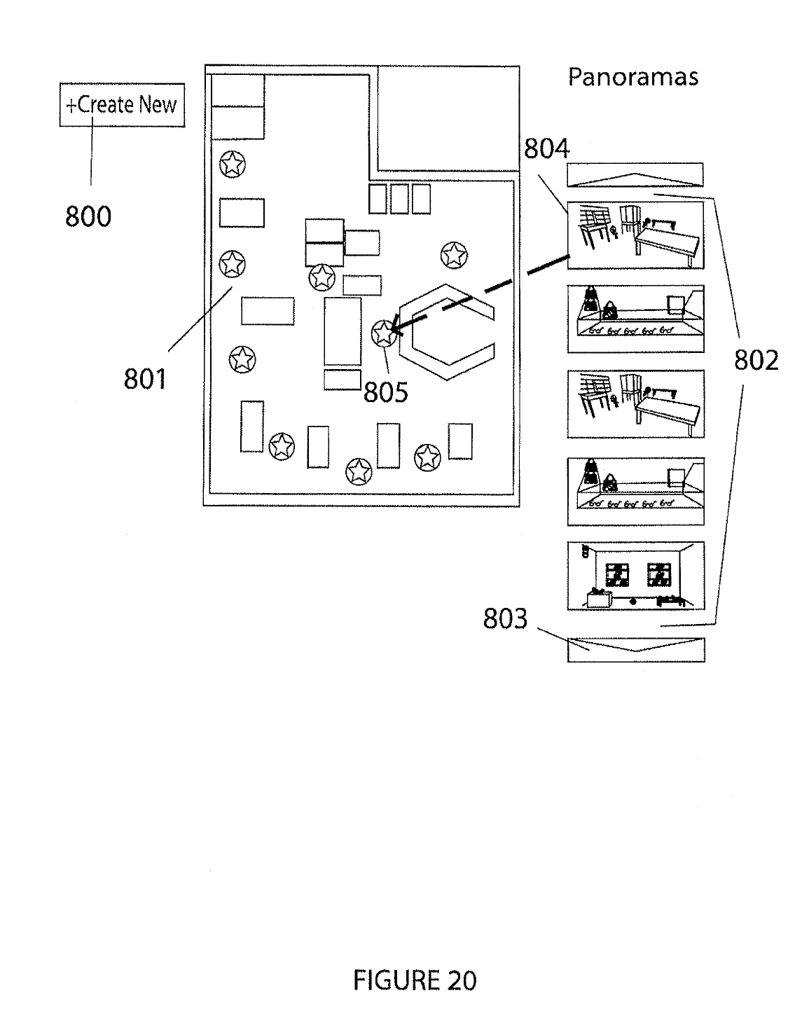

Referring now also to FIG. 20 in the drawings, the system User is provided with a rapid and efficient system to link particular panoramic images from the database to the “Mini Map” (Floor plan). The system user will click on the button 800 to create a new mini map and then upload their image to the database and the “mini map” will appear 801. The System User will then scroll through the list 802 of Panoramas using the arrows 803, click on the desired image 804, and click on the image of the “mini map” 805 to link it to the desired location.

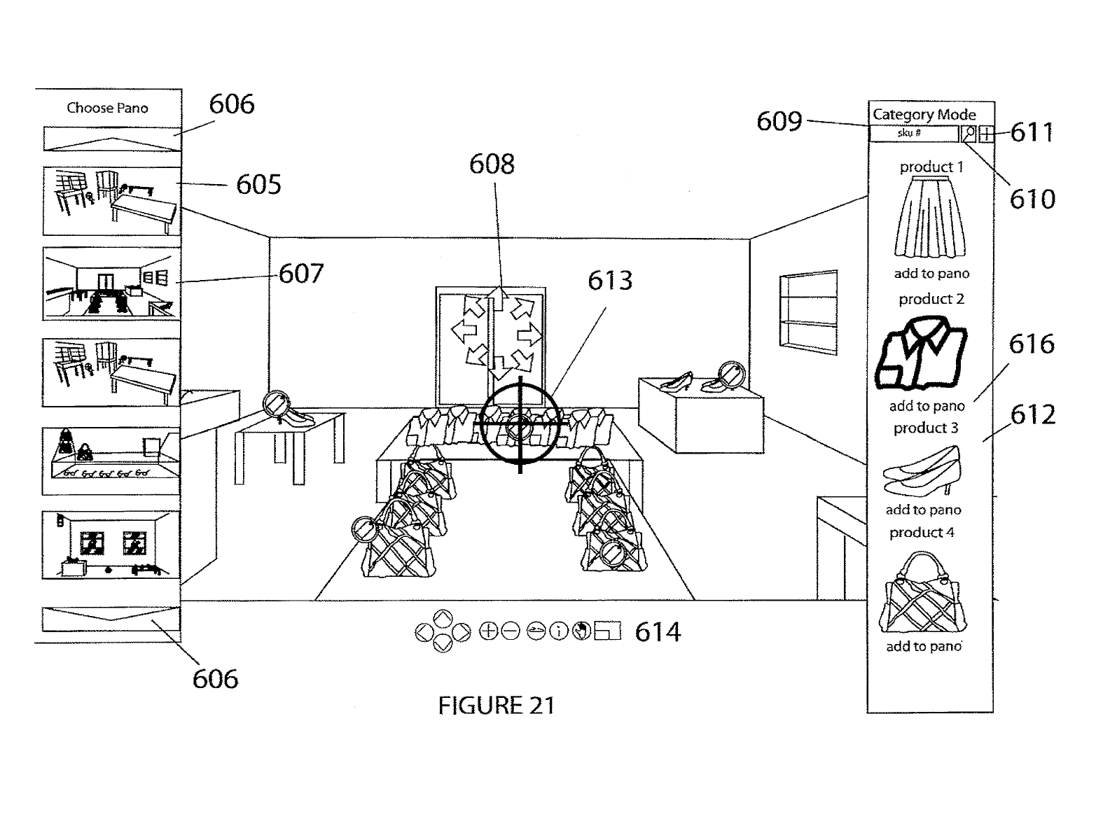

Referring now also to FIG. 21 in the drawings, the system User is provided with a rapid and efficient system to link particular items from the inventory database to the price tag on each item. The system user will scroll through the list 605 by clicking on the arrows 606, then click on the desired panorama 607 which will in large in window 608. The system user will type (or scan with bar code reading device) the SKU number into the item field 609 then click the search icon 610 and find the item. Once the item is found, click on the “+” icon 611 to add it to the item list 612 (alternatively items can be added one at a time). Then the system user will locate the desired “hot spot” by maneuvering the crosshairs 613 with the navigation bar 614 (or by dragging the screen in opposite directions by anchoring on the screen with the mouse button 615) to the desired location. The system user will then click the “add to pano” link 616 to add the item tag to the location at the center of the crosshairs 613.

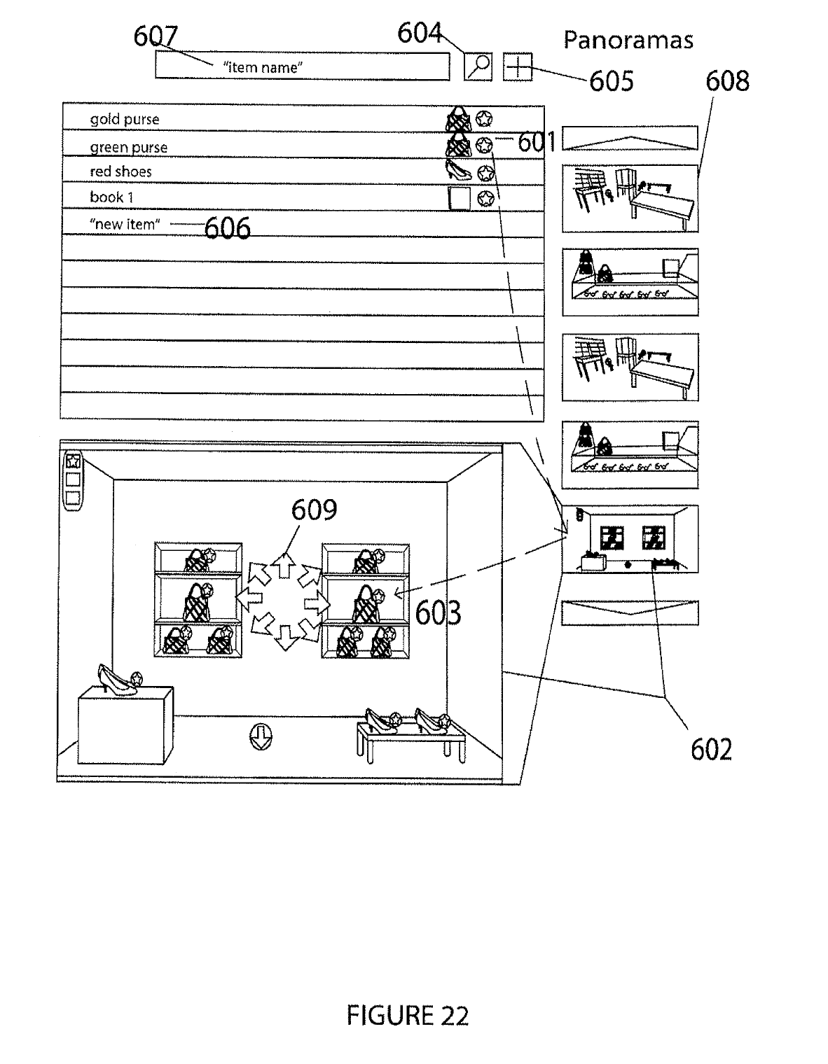

Referring now also to FIG. 22 in the drawings, the system User is provided with a rapid and efficient system to link particular items from the inventory database to the price tag on each item. The system user will type (or scan with bar code reading device) the SKU number into item field 607 then click the search icon 604) and find the item. Once the item is found, click on the “+” icon 605 to add it to the item list 606. Click and drag the item tag to the desired Panorama from the list 608 and it will enlarge to a larger size 602. With the mouse button still held down, move from side to side of the view window and the panorama will scroll omni-directionally 609 until you find the desired location inside the view window. Release the mouse button over the correct item in the Panorama to anchor the tag to that item. Additionally the user can click on the panorama first and it will stay enlarged allowing the user to drag items quickly from the list to the Panorama.

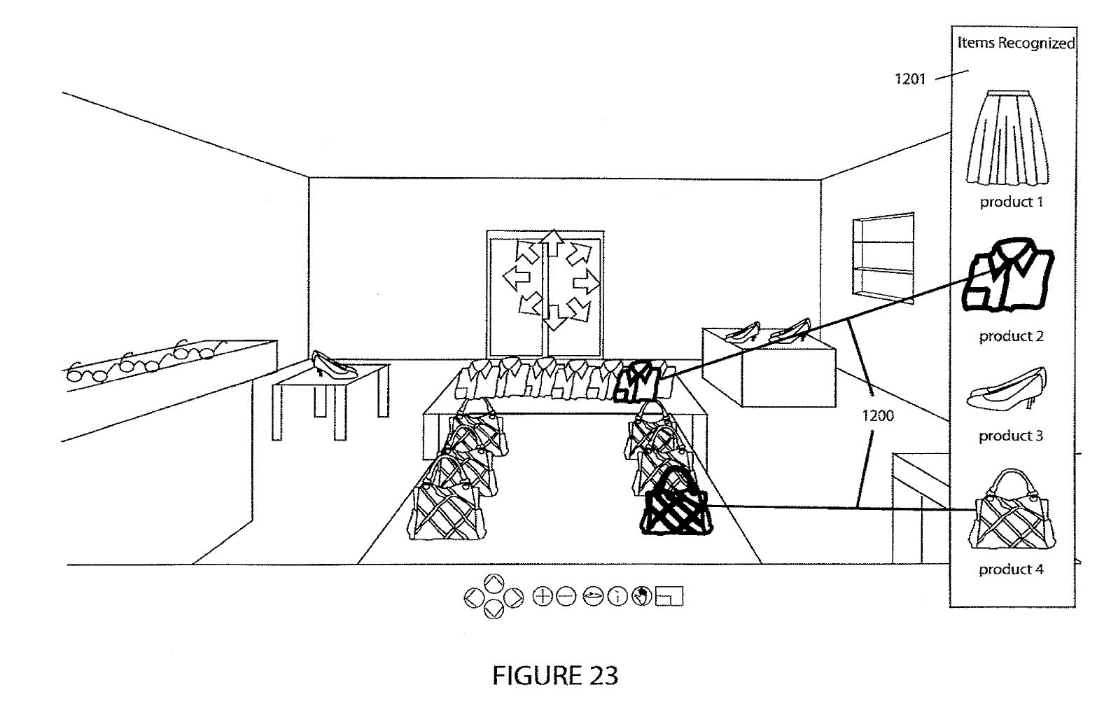

Referring now also to FIG. 23 in the drawings, by using Canny Edge Detection and other various recognition software methods to find the most likely product matches 1200 using 360 degree photos as the library of possible results 1201 (useful due to the many angles of each product). Among other methods, this is performed against each cube face during the cube manipulation and upload, instead of on the fly once the panorama has been created. By feeding a number of standard photographs for each item into the recognition program and based on their unique characteristics locating those in the panorama photographs, this enables the system user a much more rapid and efficient method to link inventory items from their standard e-commerce site to the system. Additionally, it enables the system user the option of eliminating price tags and allowing the shopper to simply click on the desired item.

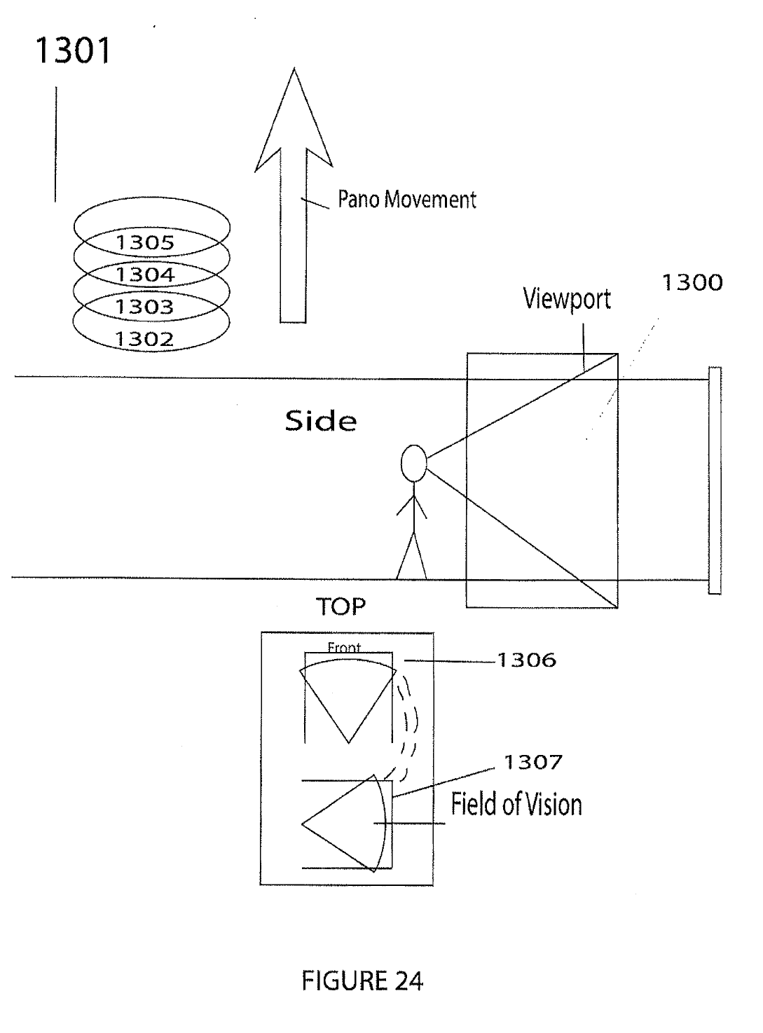

Referring now also to FIG. 24 in the drawings, by taking several panoramic photographs 1302-1305 in close proximity to one another the system provides the shopper with the sense of walking down an aisle instead of hopping from one panoramic photograph to the other. By giving the illusion of depth the system will be setting a fixed viewport and image updates will only occur inside the viewport 1300. As the user “walks” through the store 1301 the viewport gets the coordinates sent and enlarges the image or shrinks the image 1302-1305. By only loading the pixels required for the field of vision selected by the shopper, the process has created a much smoother experience similar to walking down the aisles. Physical store. For example the pixels in field of vision 1307 are not loaded into the system until the shopper turns from field of vision 1306 towards field of vision 1307.

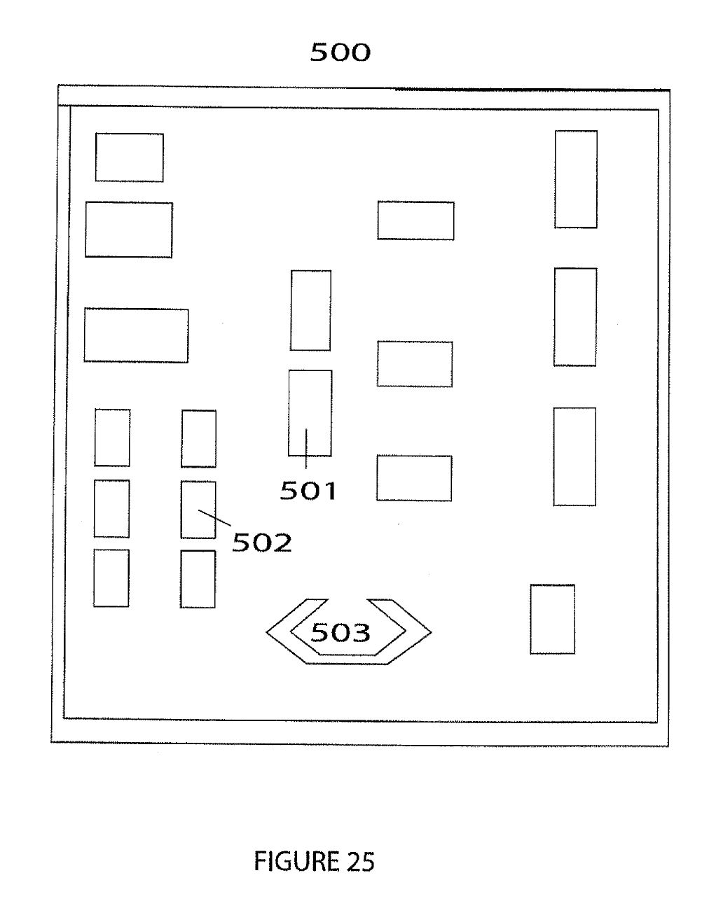

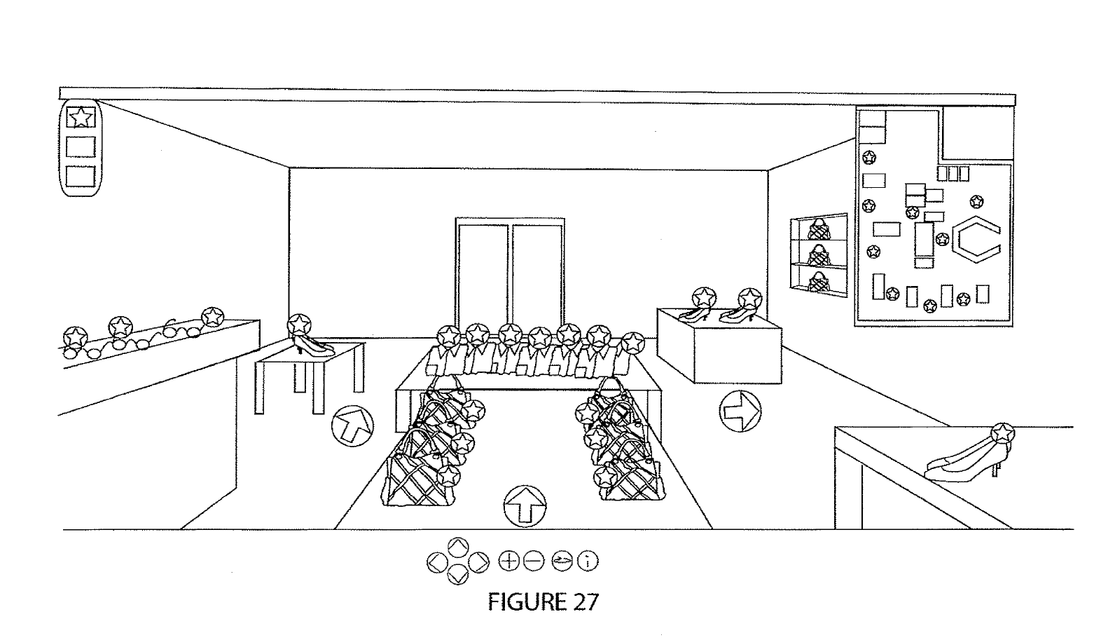

Referring now also to FIG. 25 in the drawings, a preferred embodiment of the navigable, interactive, panoramic environment with an embedded window providing the ability for online only retailers to create a realistic, lifelike and navigable store environment similar to an existing brick-and-mortar facility 500. The process would involve utilizing inexpensive warehouse space 500 to create a “mock store” with shelving, clothing racks, showroom areas etc. 501,502, 503 in which the retailer would ship items to the warehouse facility, have them placed upon the shelving, clothing racks or into showroom areas at which time a series of panoramic photographs would be created and spaced in such a manner that the end-user/shopper could navigate throughout the store from panoramic photograph to panoramic photograph, select and purchase items that have price tags embedded as “hotspots” linked to the retailers existing e-commerce site (as shown in FIG. 27). This would enable the retailer the ability to provide its customers with a new way to shop that is similar to their “real world” brick and mortar experience which involves browsing through the aisles (as shown in FIG. 27).

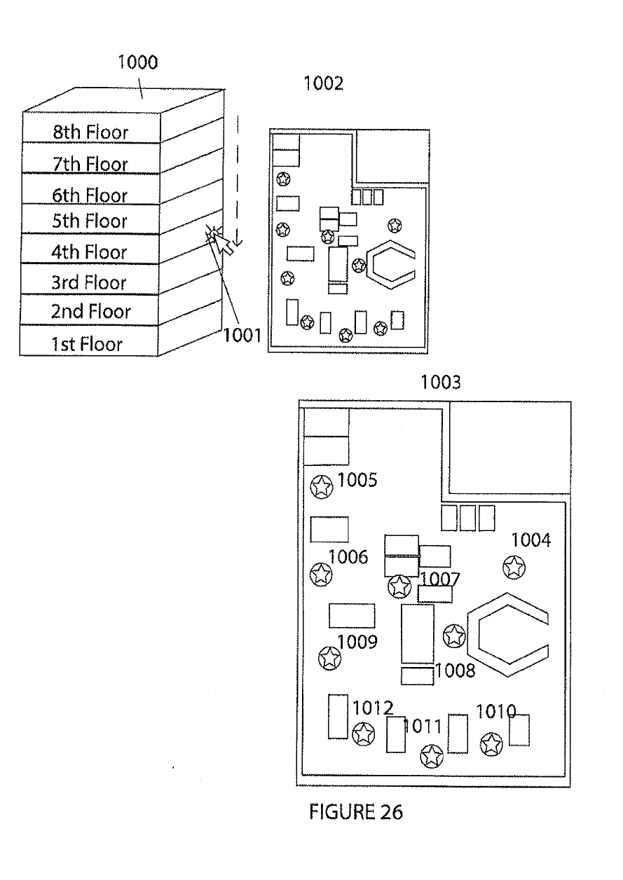

Referring now also to FIG. 26 and FIG. 27 in the drawings, for larger stores with several departments the shopper is provided with a rapid and efficient system to navigate virtually and quickly through the various floors associated with each department in the navigable, interactive, and panoramic environments using the “elevator” 1000. The shopper will move the mouse hover over the different floors 1001, and the floor map will fly out to the right 1002. When the shopper finds and clicks on the desired floor 1001 the system will immediately port them to that floor map 1003 in which they can navigate to different sections of that particular department. Once they choose a location to “land” they will click on the icon/hotspot 1004-1012, and move into the store as illustrated in FIG. 27 and be able to move and navigate through the store from panoramic photographs to panoramic photograph select and purchase items that have price tags embedded as “hotspots” linked to the retailers existing e-commerce site. This would enable the retailer the ability to provide its customers with a new way to shop that is similar to their “real world” brick and mortar experience which involves browsing through the aisles.

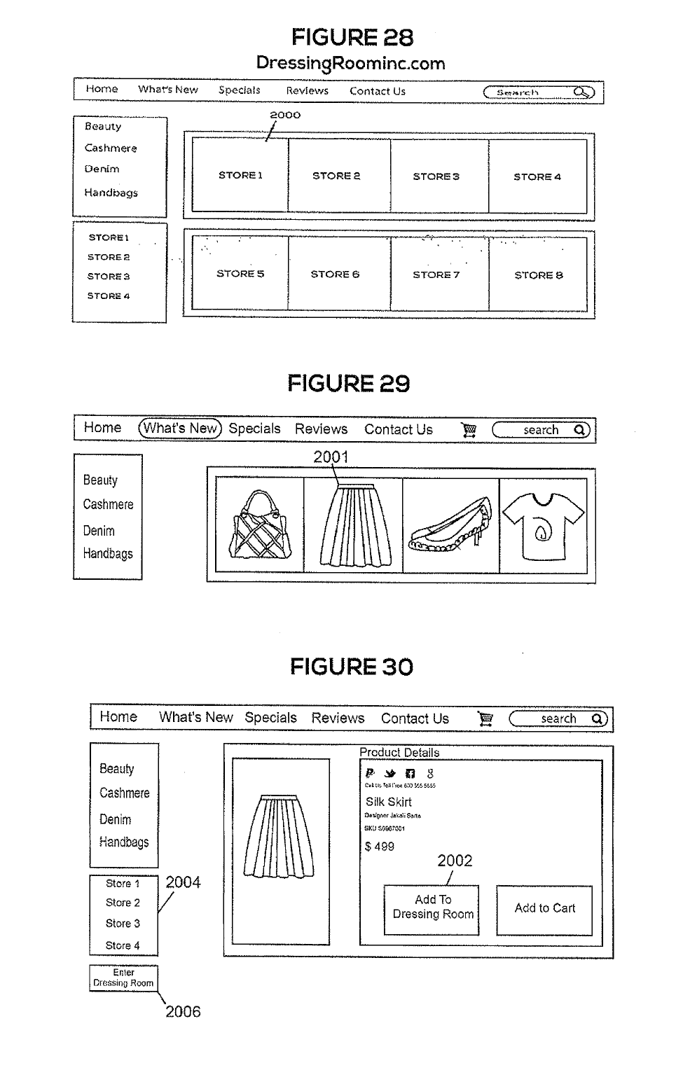

Referring now also to FIG. 28, the main page of the dressing room on a free standing separate website, the shopper is able to navigate to any online store that is within the network, whether in the virtual panoramic environment or standard e-commerce site. Once the shopper has selected their store of choice 2000, the software will then take him/her to that specific web page so that they can browse around and select an item

Referring now also to FIG. 29, when the shopper finds a product that he/she likes 2001, they will click that item and it will take the user to that items specific page.

Referring now also to FIG. 30, the user will then click the “Add to Dressing Room” icon 2002 that is displayed next to the selected item. The item will them be placed in a global dressing room 2003. The shopper can then choose to select another second online store 2004 and view the products that the second store 2004 currently has online. If the shopper selects an item from the second store 2004, they will then press the “Add to Dressing Room” icon 2002 that is displayed next to the selected item. The item will them be placed in a global dressing room 2006. Once the shopper has selected all of his/her items and added them to their dressing room, the shopper will then be able to navigate to their dressing room 2006 and mix and match items to create outfits.

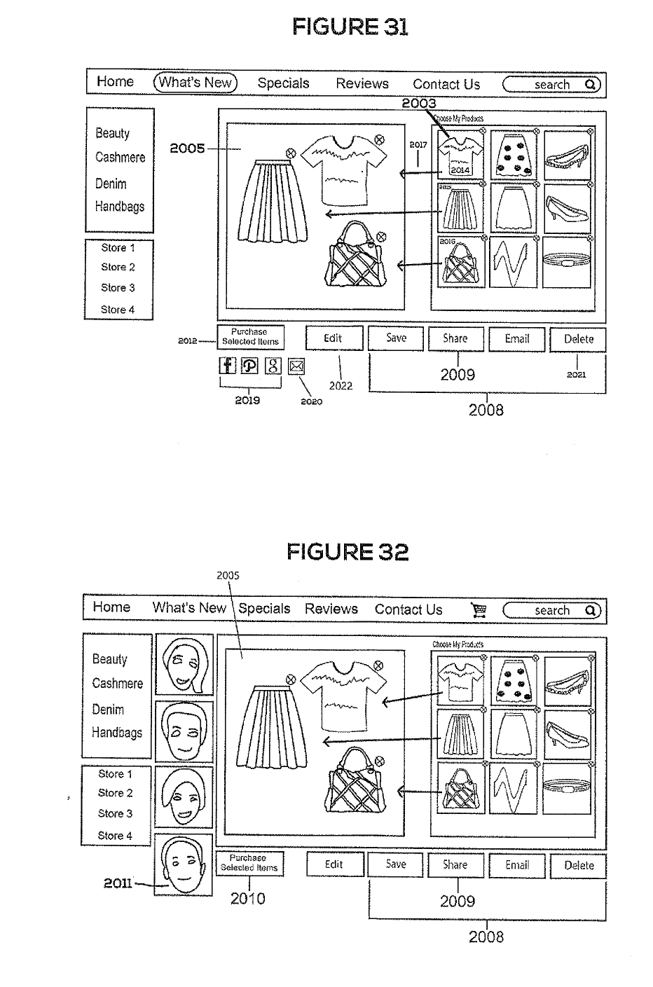

Referring now also to FIG. 31 in the drawings, the Shopper and/or salesperson is provided with an alternative rapid and efficient system to compare and match articles of clothing in the “Dressing Room” to create outfits using the drag and drop method. If using an iPad or mobile device, the shopper can also click on the item to add it to the “mirror” 2005. A list of products 2003, such as the blouse 2014, the skirt 2015, and the handbag 2016 can be dragged 2017 into the mirror 2005 if using an iPad or mobile device, so the shopper and/or salesperson can mix, match, and position each product. To remove the products individually, click or tap on the X icon in the upper right hand corner, or use the “delete” 2021 button to clear the entire area.

Referring now also to FIG. 31, once an outfit 2005 is created, the shopper will then be able to save, share, email or delete 2008 their outfit, as well as edit previously saved outfits 2022. If the shopper chooses to share their outfit 2009, they will then have the option to send for viewing via social media 2019 or by email 2020. The receiving party can view the shared outfit, and by joining and becoming a member, you can edit and make suggestions to the sender.

Referring now also to FIG. 32, the shopper can invite friends to join their shopping experience 2011. By joining the shopping experience, the invited friends will be able to shop together in real-time as well as mix and match outfits together. The shopper and his/her friends will then have the ability to take turns controlling the dressing room and move or select different items. Once the shopper has decided on which outfit he/she would like to purchase, they will then have the option to purchase all items 2010 in the “mirror” 2005 that are associated with each outfit. If using an iPad or mobile device, the shopper can also click on the item to add it to the “mirror” 2005.

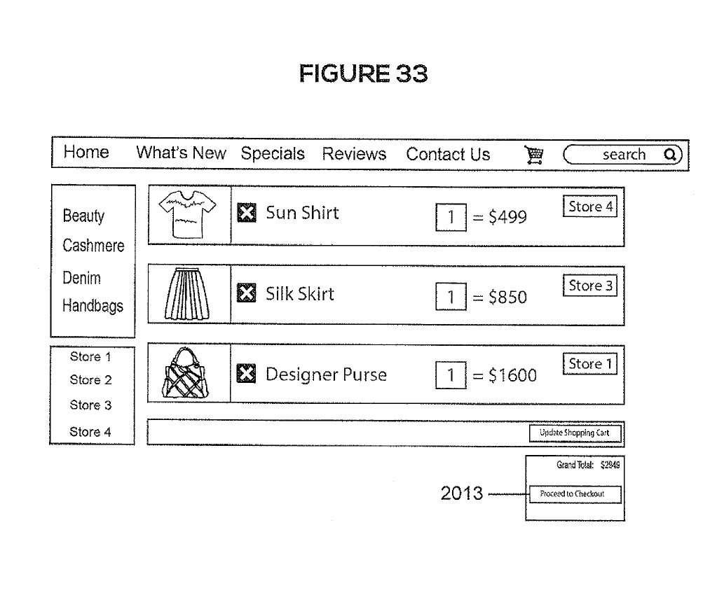

Referring now also to FIG. 33, once the user has decided on which outfit they would like to purchase, it will then take that user to the shopping cart where they can check out 2013. Once a purchase has been complete, the system will then distribute the funds to each online retailer for the purchase. Once the retailer receives the purchase, they will then ship the item as if it was purchased directly from the store.

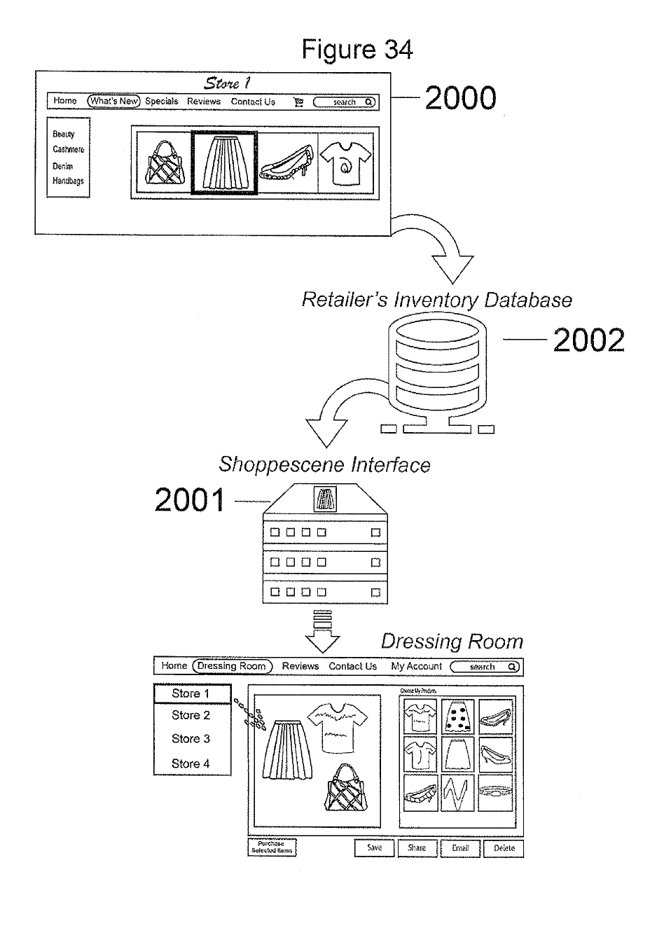

Referring now also to FIG. 34 in the drawings, a retailer that is associated with the Dressing Room 2000 will integrate their current inventory by using the system's interface 2001 to communicate and exchange information with their main inventory database 2002.

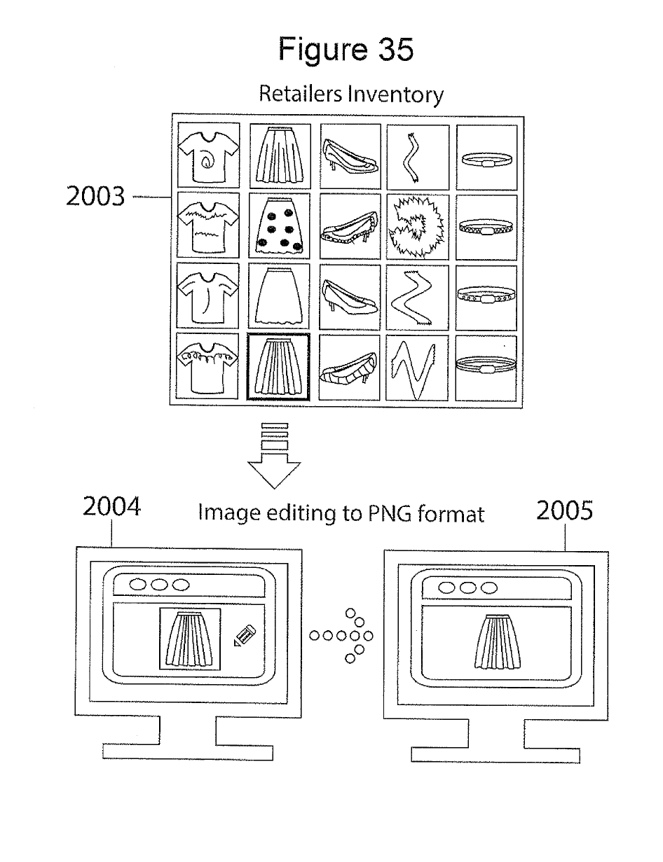

Referring now also to FIG. 35 in the drawings, the retailer will supply the Dressing Room with images of their current inventory 2003. Those images will be edited 2004 to remove the background including but not limited to images of models and will be converted into PNG format so that each item can be scalable and have transparent backgrounds for the best dressing room experience 2005.

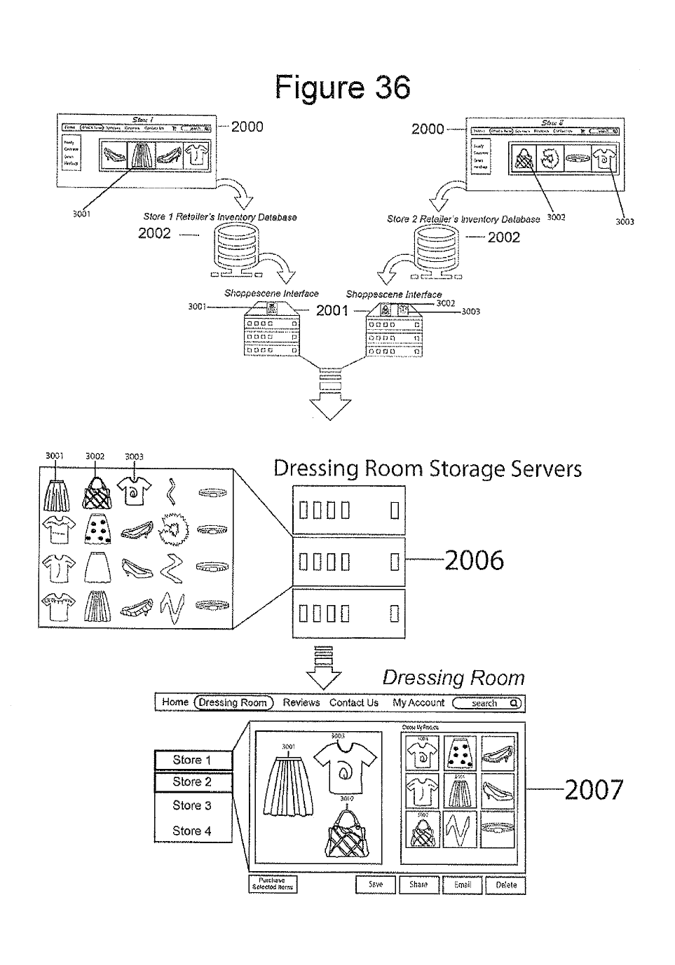

Referring now also to FIG. 36 in the drawings, the converted images will be stored on the system's Dressing Room Image storage servers 2006 and added to the Dressing Room 2007 as selected by a shopper based on a unique database ID number that will signal the interface 2001 to pull the selected items 3001, 3002, 3003 from the reservoir 2006 of edited photos and populate into the Dressing Room 2007. the database interface 2001 will communicate with the Dressing Room 2007 and retailer's inventory database to update and indicate out of stock, going on sale etc. based on quantity and size, etc. Once a purchase has been complete, the system will distribute the funds to each online retailer for its respective item purchased. The retailer will receive notification from the interface to ship the item the shopper.

It is apparent that a system and method with significant advantages has been described and illustrated. The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A method for facilitating social e-commerce, comprising:
creating a first store panoramic image containing a first item from a first store;
creating a first image of the first item from the first store from a first perspective; and
embedding a first hotspot in the first store panoramic image coupled to a position of the first item from the first store in the first store panoramic image;
allowing a first user to move the first store panoramic image, thereby simulating moving around the first store.

2. The method of claim 1, further comprising:
creating a first image of a second item from the first store from the first perspective; and
providing a virtual rack room;
wherein the virtual rack room contains the first image of the first item from the first store and the first image of the second item from the first store, both images partially overlapped so the first item from the first store and the second item from the first store appear to be displayed on a combined rack.

3. The method of claim 1, the step of creating a first store panoramic image comprising:
stitching a first partial panoramic image to a second partial panoramic image; and
blending the first partial panoramic image to the second partial panoramic image.

4. The method of claim 1, further comprising:
creating a second image of the first item from the first store from a second perspective; and
combining the first image of the first item from the first store and the second image of the first item from the first store to create a panoramic view of the first item;
wherein the panoramic view of the first item from the first store allows a user to see all sides of the first item.

5. The method of claim 1, further comprising:
allowing a second user to move the first store panoramic image thereby simulating moving around the first store; and
providing a communication tool to allow communication between the first user and the second user.

6. The method of claim 1, further comprising:
creating a second store panoramic image containing a first item from a second store;
creating a first image of the first item from the second store from the first perspective; and
embedding a first hotspot in the second store panoramic image coupled to a position of the first item from the second store in the second store panoramic image;
allowing the first user to move the second store panoramic image, thereby simulating moving around the second store;
providing a master shopping cart, wherein the first user can purchase items from the first store and the second store in a single transaction.

7. The method of claim 5, further comprising:
allowing the second user to make suggestions to the first user about the first item; and
providing the second user with a way to purchase the first item for the first user.

8. The method of claim 1, further comprising:
creating a first image of a second item from the first store from the first perspective; and
providing a virtual dressing room
producing a first virtual outfit from the first image of the first item from the first store and the first image of the second item from the first store;
wherein the virtual dressing room contains the first image of the first item from the first store, the first image of the second item from the first store, and the first image of the third item from the first store; and
wherein the first user can position the first image of the first item relative to the first image of the second item.

9. The method of claim 8, further comprising:
allowing the user to provide a copy of the first virtual outfit to a social media site.

10. The method of claim 1, further comprising:
creating a first series of panoramic images related to a first floor of the first store;
creating a second series of panoramic images related to a second floor of the first store;
allowing the first user to roam the first series of panoramic images, thereby simulating moving around the first floor of the first store; and
allowing the first user to roam the second series of panoramic images, thereby simulating moving around the second floor of the first store;
wherein the first item is located somewhere either in the first series of panoramic images or the second series of panoramic images.

11. A system for facilitating social e-commerce, the system comprising:
an imaging system, for creating an image of a panoramic space and for creating an image of an item for sale;
a computer system, for storing the image of the panoramic space and for storing the image of an item for sale; and
a software system, for combining the image of the panoramic space and the image of the item for sale so that a first user can shop virtually for the item for sale in the panoramic space.

12. The system according to claim 11, the imaging system comprising:
a spherical video camera;
wherein the spherical video camera allows for frequent navigation points, creating the illusion of free movement within the panoramic space.

13. The system according to claim 11, the computer system comprising:
a first networked computer, for storing the image of the panoramic space and for storing the image of the item for sale; and
a second networked computer for the first user;
wherein the first user utilizes the second networked computer in networked communications with the first networked computer to view, interact, and purchase the item for sale.

14. The system according to claim 13, the computer system further comprising:
a third networked computer for a second user;
wherein the second user utilizes the third networked computer in networked communications with the first networked computer and the second networked computer to view, interact, and purchase the item for sale; and
wherein the second networked computer and the third networked computer are coupled so that the first user and the second user can communicate directly between each other.

15. The system according to claim 11, the software system comprising:
a first program to stitch a first partial panoramic image to a second partial panoramic image; and
a second program to blend the first partial panoramic image to the second partial panoramic image.

16. The system according to claim 13, wherein first networked computer and the second networked computer are configured to allow social interaction between the first user and the second user.

17. The system according to claim 13, wherein the second networked computer comprises:
a tablet, comprising;
a touch screen, for allowing the first user to interact and move about the panoramic space;
a camera, for taking pictures of the first user to be transmitted;
a microphone;
a speaker;
a storage device, for locally storing information; and
a network device, for allowing the tablet to be in digital communications with the first networked computer.

18. A method for facilitating social e-commerce, comprising:
creating a first image of a first item from a first store;
removing the background from the first image of a first item from a first store;
creating a first image of a first item from a second store;
removing the background from the first image of a first item from a second store;
providing a virtual dressing room; and
producing a first virtual outfit from the first image of the first item from the first store and the first image of the first item from the second store;
wherein the virtual dressing room contains the first image of the first item from the first store, and the first image of the first item from the second store; and
wherein a first user can position the first image of the first item from the first store relative to the first image of the first item from the second.

19. The method of claim 18, further comprising:
creating a first image of a second item from a first store;
allowing a second user to change the first image of the first item from the first store to the first image of the second item from the first store; and
providing a communication tool to allow social interaction between the first user and the second user.

20. The method of claim 18, further comprising:
providing a master shopping cart, wherein the first user can purchase items from the first store and the second store in a single transaction.
